(19) United States
(12) Patent Application Publication
(10) Pub. No.: US 2024/0360719 A1
(43) Pub. Date: Oct. 31, 2024

(54) CONSTRUCTION PROFILE, IN PARTICULAR FOR A WINDOW OR DOOR FRAME, A WINDOW OR DOOR FRAME COMPRISING SUCH CONSTRUCTION PROFILE AND A RESULTING WINDOW OR DOOR

(71) Applicant: DECEUNINCK NV, Hooglede-Gits (BE)

(72) Inventors: Peter DEGRANDE, Hooglede-Gits (BE); Niki VAN DER EECKEN, Hooglede-Gits (BE); Karel VANALDERWEIRELDT, Hooglede-Gits (BE)

(21) Appl. No.: 18/687,693

(22) PCT Filed: Aug. 31, 2022
(86) PCT No.: PCT/EP2022/074166

§ 371 Date: Feb. 28, 2024

(30) Foreign Application Priority Data
Sep. 1, 2021 (EP) 21194404.6

(51) Int. Cl. E06B 3/26

(52) U.S. Cl. CPC E06B 3/26; E06B 2003/2615; E06B 2003/262

(57) ABSTRACT

A construction profile, in particular for a window or door frame, includes: a) a polymeric core profile; b) a metallic side profile structurally attached to the polymeric core profile such that the polymeric core profile and the metallic side profile behave as a single structural entity. The construction profile defines a room side that in use faces an interior of a building, and an exterior side that in use faces the outdoors. The polymeric core profile includes side walls defining a cavity divided in multiple inner rooms separated by inner walls extending in a longitudinal direction of the construction profile. The metallic side profile is provided on a side wall of the polymeric core profile facing the interior, external of the polymeric core profile.

### FIELD OF THE INVENTION

The present invention relates to a construction profile, in particular for a window or door frame, said profile comprising:
a polymeric core profile;
a metallic side profile structurally attached to the polymeric core profile;
said construction profile defining a room side that in use faces an interior of a building, and a outer side that in use faces the outdoors,
wherein said polymeric core profile comprises side walls defining a cavity divided in multiple inner rooms separated by inner walls extending in a longitudinal direction of the construction profile.

The present invention also relates to window or door sash frames comprising one or more of such construction profiles as well as to window or door sashes made from such frames.

### BACKGROUND TO THE INVENTION

Profiles for the production of window and door frames are known which can be covered with metallic profiles or with profiles made of other materials, using clip-on elements attached to said profiles and spaced apart from one another.

This system is often used by the external attachment of aluminum profiles as external protection against the effects of the weather for wooden frames.

In case of polymeric frames, the use of metallic side profiles is known for aesthetic reasons mimicking an aluminum profile look, for protection against the effects of weather of the polymeric profiles such as disclosed in EP2594720. As polymeric materials on their own lack the strength needed to support larger window panes or to withstand high wind loads on large windows, it is mandatory to reinforce polymeric profiles either by providing metallic inserts in the polymeric profiles, by structural reinforcing metallic side profiles or by a combination of both.

Window sash frames are known (eg. from DE 10 2019 122 295) where metallic side profiles are provided on the outside facing side of the polymeric profile or at both the outside facing side and the room side of the polymeric profile (EP2594720).

Providing metallic reinforcing inserts in polymeric profiles is cumbersome, labour intensive and diminishes the insulative properties of the profiles as the metal insert creates a thermal bridge in the profile.

Providing metallic side profiles that remain visible after assembly and installing a window requires craftsmanship as during assembly, the polymeric core profiles are joined to one another by welding in the corners of the frame. As the metallic side profiles can not be joined as such when welding the polymeric core profiles, the dimensions of the metallic side profiles need to be very precisely determined such as not to create stress on the profiles when facing edges of the metallic side profiles abut after welding the polymeric core profiles or to prevent occurrence of a gap between two adjacent metallic side profiles in the corners of the frame.

This dimensioning of the side profiles remains a drawback for the use of metallic side profiles, especially as polymeric materials and metallic materials have different thermal expansion coefficients. Thus, when a window comprising polymeric profiles covered with metallic side profiles at outside facing side, the metallic side profiles will expand over different distances than the polymeric profile on warm or sunny days, which not only results in stresses building up in the profile itself but might also cause the metallic side profiles to drift out of one another or just bump into another at the corners of the window, with a risk of bulging of the metallic side profiles.

It follows from the above that a market need exists for polymeric window or door frame profiles having different structural features, which have high thermal insulative properties and provide high dimensional stability, without the mandatory use of internal reinforcement profiles provided in a hollow chamber of the polymeric profile.

### SUMMARY OF THE INVENTION

The present invention addresses the above market need by providing a construction profile, in particular for a window or door frame, said profile comprising:
a) a polymeric core profile;
b) a metallic side profile structurally attached to the polymeric core profile;
   said construction profile defining a room side that in use faces an interior of a building, and a outer side that in use faces the outdoors,
   wherein said polymeric core profile comprises side walls defining a hollow chamber divided in multiple inner rooms separated by inner walls extending in a longitudinal direction of the construction profile;
   characterised in that said metallic side profile is provided on a side wall of the polymeric core profile facing the interior, external of said polymeric core profile and in that the opposite side wall of the polymeric core profile is free of an external metallic and structurally reinforcing side profile.

The present invention also concerns a window or door frame comprising construction profiles according to the present invention, wherein the polymeric core profiles of two adjacent construction profiles are welded together at their facing end surfaces, forming a corner.

The present invention also concerns a window or door comprising a window or door frame according to the present invention and comprising a pane installed in the window or door frame, wherein said pane is positioned off-set the centre of the depth of the window or door frame towards the interior facing side of the window or door frame.

### BRIEF DESCRIPTION OF THE DRAWINGS

FIG. 1 shows a cross-section of a construction profile according to the present invention;

FIG. 2 shows a cross-section of an alternative embodiment of a construction profile according to the present invention;

FIG. 3 shows a cross-section of another alternative embodiment of a construction profile according to the present invention.

### DETAILED DESCRIPTION OF THE PRESENT INVENTION

A window or door according to the present invention comprises a window or door frame assembled from typically four construction profiles that are joined to create a rectangular frame suitable for receiving a pane such as a glass pane.

The window or door is configured to be applied in an architectural opening to close off an interior from the exterior. The construction profiles and frame assembled thereof have a specific orientation, with a room side (R) designed to face the interior of a building and an outer side (O) facing the exterior. The glass pane installed in the frame herewith extends in a Y-Z plane, orthogonal to an X-axis that extends perpendicular to the Y-Z plane. This X-Y-Z orientation will be used consistently throughout the following description, for the window or door and for the concerned construction profiles, whereby the orientation is always used vis-à-vis the orientation of the construction profiles when in installed as a window or door in an architectural opening.

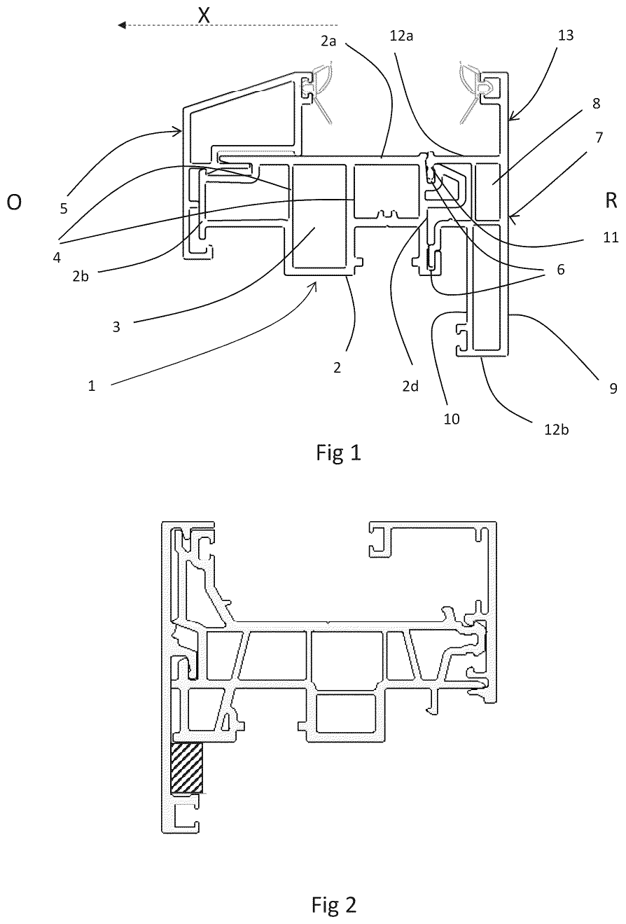

As illustrated in FIG. 1, the present invention concerns an elongated construction profile and more in particular an elongated window or door frame profile. The elongated profile of the invention comprises a polymeric core profile 1 comprising side walls 2a-d defining a cavity 3 divided in multiple inner rooms separated by inner walls 4 extending in a longitudinal direction of the construction profile. One or more of the rooms may be filled with a foam material or may comprise a reinforcement profile.

The polymeric core profile comprises a specific cross-section, whereby at least part of the inner walls extend in the Y-Z plane, thereby creating several subsequent and separate inner rooms along an X-axis to increase the thermal insulation capacity of the polymeric core profile in the X-direction.

The side walls 2a and 2c of the polymeric core profile form respectively a window receiving surface, facing the interior of the frame and the circumscribing outer surface of the window frame. The other side walls 2b and 2d extend predominantly in the Y-Z plane, whereby 2b is configured to face the outer side (O) whilst 2d is configured to face the room side (R).

Side wall 2b, configured to the outer side (O) is preferably provided with a releasable glass rebate 5, while the opposed side wall 2d, is provided with coupling means, in this case a grooves 6.

The polymeric core profile is preferably made from a weldable thermoplastic material, most preferably polyvinylchloride (PVC).

The construction profile also comprises a metallic side profile 7, optionally a metallic side profile defining at least one or more inner rooms 8 as illustrated in FIG. 1. In accordance with the present invention, the metallic side profile is provided on a side wall of the polymeric core profile facing the room side, external of said polymeric core profile.

The metallic side profile is configured to be structurally coupled with the polymeric core profile and comprises a room facing side surface 9 that is visible when the window or door is installed and closed, and an exterior facing surface 10 designed to cooperate with the room facing side of the polymeric core profile. In this case coupling means in the form of two hook like protrusions 11 are provided on the exterior facing surface of the metallic side profile. For the sake of the present invention, structurally attached is defined in that the connection between the metallic side profile and the polymeric core profile is such that the polymeric core profile and the metallic side profile behave as a single structural entity. This can for example be achieved by either connecting both profiles by a continuous connection (eg. a dove tail groove and tongue connection) in a longitudinal direction of the construction profile and over substantially the entire longitudinal direction of the construction profile or at multiple discrete points equally spread along in the entire longitudinal direction of the construction profile (eg. anchoring points protruding from the metallic side profile and extending into or through the side wall 2c of the polymeric core profile.

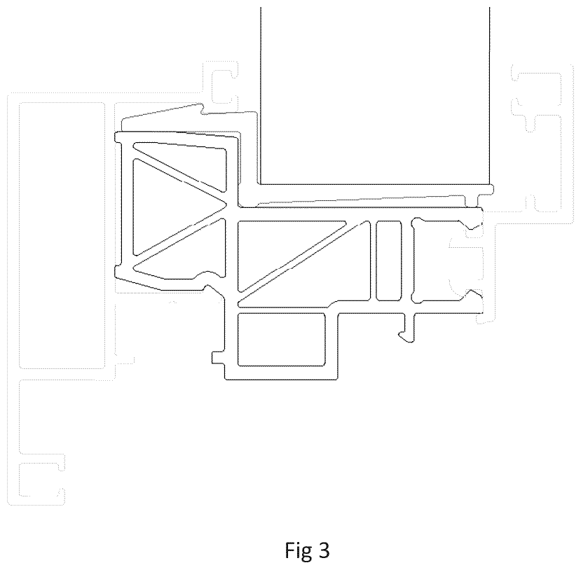

As illustrated in FIGS. 1 & 2, each hook-like protrusions 11 extends in a longitudinal direction over substantially the entire length of the metallic side profile, and is configured to snuggly fit into the grooves 6 of the polymeric core profile to obtain the construction profile of the invention. In the embodiment of FIG. 1, the metallic side profile comprises a rebate structure 13 that in an assembled state of the construction profile forms the fixed glass rebate. Alternatively, as illustrated in FIG. 2, the metallic side profile extends along and covers a rebate structure that is part of the polymeric core profile.

The metallic side profile is preferably made in aluminium or steel.

The assembled construction profile of the invention thus preferably comprises two rebates 5 and 13, delimiting a so-called pane receiving zone. In the embodiment of FIG. 1 this pane receiving zone is partially defined by the polymeric core profile, in particular side wall 2a thereof and partially by the metallic side profile, in particular side wall 12a thereof. In the embodiment of FIG. 2, the pane receiving zone is entirely defined by the polymeric core profile, yet an auxiliary piece provided between sidewall 12c and a protrusion provided on the metallic side profile prevents accidental sliding of the metallic side profile in a direction wherein the hook-like protrusions thereof would be released from the polymeric core profile.

In the embodiments of both FIGS. 1 and 2, the pane receiving zone is hereby preferably somewhat off-set from the centre of the depth (X-direction) of the construction profile, such that a pane received in the window or door frame partially rests on the construction profile in vicinity of the metallic side profile that has a depth (in the X-direction) smaller than the depth of the polymeric core profile.

At the opposite side wall, defined by sidewall 2c of the polymeric core profile and by the side wall 12b of the metallic side profile, the construction profile comprises grooves designed to receive window or door hardware.

Alternatively, as shown in FIG. 3, a set of glass bridges can be used to transfer part of the glass weight on the polymeric core profile to the metallic side profile. The glass bridges have a limited length in the longitudinal direction of the core profile and are spaced apart along that direction, although providing one glass bridge extending over the entire of substantially entire length of the core profile is also possible.

The glass bridges are configured to be provided in the pane receiving zone. In this case comprises three sections, a first section designed to carry a glass pane; a second section designed to engage with the metallic side profile and an intermediate section extending substantially perpendicular to the first and second sections and connecting both the first and second sections. In the embodiment of FIG. 3, the first section comprises at least one protrusion located at the room side (R) of the pane receiving zone. This protrusion creates a lever between the first and second sections of the glass bridge such that the second section is biased in a direction opposite to the pressure exerted by a glass pane on the first section.

The second section comprises a shoulder portion configured to define a clips connection with the metallic side profile at the room side of the construction profile, such that the lever transfers part of the force applied on the first section of the glass bridge to the metallic side profile in a direction towards the glass pane and in a direction opposite to the direction of the pressure exerted on the first section of the glass bridge by the glass pane.

The provision of the above disclosed set of glass bridges, wherein the structural coupling connection between the metallic side profile and the polymeric core profile is partially achieved by the clips connection between the metallic side profile and glass bridge has the advantage that the construction tolerances for the polymeric profile and the concerned metallic profile, especially at their mutual attachment points becomes less stringent than in case the attachment is made directly between both without the intermediate glass bridge.

In an assembled state of a window or door frame of the invention, the polymeric core profiles of the adjacent construction profiles are welded together, forming a rigid and permanent bond between the construction profiles in the corners of the window or door. The corner joints can be either mitred or straight angled. To achieve a rigid and permanent welded bond, the metallic side profiles and locally removed in proximity of the corners prior to welding such that the polymeric core profile protrudes a few millimetre from the metallic profiles in a direction perpendicular to the corner joint to be achieved.

While in the illustrated embodiment, the connection between the polymeric core profile and the metallic side profile is achieved by a hook in groove clips connection, other structural connections between both can be used alternatively, such as dovetail joints, adhesives or other mechanic connection means.

In accordance with a preferred embodiment of the present invention, the exterior facing side of the construction profile is free from a structurally reinforcing metallic side profile and can hence be entirely made up by the polymeric core profile, although aesthetic metal sheet coverings can also be applied. The releasable rebate can be made in either polymeric material such as PVC or in a metallic material such as aluminium or stainless steel.

A window or door of the present invention has the benefit that, on the one hand the insulative properties of the polymeric profile remain optimal as there is no need for a metallic internal reinforcement profile and on the other hand material stresses due to differential thermal expansion between the polymeric core profile and the metallic side profile are minimized as the metallic side profile is situated that the room side of the construction profile and hence not directly exposed to sunlight or large temperature changes typical for the exterior side.

By defining the pane receiving zone off-set the centre of the depth of the construction profile and by preferably defining part of the pane receiving zone by the metallic side profile, the strength of the metallic side profile is optimally used for carrying the window and the glass pane, making the construction profile of the invention particularly suitable for making window or door sashes.

A construction profile according to the present invention lacks a metallic side profile structurally attached to the exterior side of the polymeric core profile. This however does not exclude the presence of a second metallic side profile coupled to the exterior side of the polymeric core profile, yet in case such second metallic side profile is provided it is to be coupled to the polymeric core profile by means of a connection that allows shifting of the second metallic profile in view of the polymeric core profile in a longitudinal direction and as such allows for a sliding or shifting of the second polymeric profile in view of the polymeric core profile when undergoing thermal expansion. For safety reasons, the second metallic side profile is coupled to the polymeric core profile such that it is retained in the X-direction.

A window or door frame assembled from construction profiles according to the present invention is less prone to bulging of the construction profiles or to the metallic side profiles to drift out of one another or just bump into another at the corners of the window for the reason that the thermal expansion at the interface of the polymeric profile and the metallic side profile structurally attached to the polymeric core profile is situated at the room side of the window or door frame, where temperature differences are far smaller than the temperature differences at the exterior side of the window or door. Indeed, at room side, temperatures will in general vary between 12° C. and 25 to 30° C., whereas at the exterior side of the window, temperatures may rise to 80° C. or more in case of direct sunshine hitting the window or door and may fall to −20° C. or less in winter conditions.

For a 2.5 m long (at 20° C.) PVC profile having a coefficient of thermal expansion of

50.4 10⁻⁶ K⁻¹ and a 2.5 m long (at 20° C.) aluminum profile having a coefficient of thermal expansion of 23.4 10⁻⁶ K⁻¹ the difference in length at 80° C. is 4.1 mm. This means that in a 2.5 m long construction profile, where the polymeric core profile is not directly exposed to sun light and the metallic side profile, structurally attached to the polymeric core profile at an exterior side thereof (prior art) is exposed to direct sunlight, a length difference of more than 4.1 mm is to be compensated by deformation of the profile, whereas for a construction profile of the present invention, a length difference of about 1.2 mm is to be compensated for in the construction profile.

1.-15. (canceled)

16. A construction profile, in particular for a window or door frame, said profile comprising:
a) a polymeric core profile;
b) a metallic side profile structurally attached to the polymeric core profile such that the polymeric core profile and the metallic side profile behave as a single structural entity;
said construction profile defining a room side that in use faces an interior of a building, and an exterior side that in use faces the outdoors,
wherein said polymeric core profile comprises side walls defining a cavity divided in multiple inner rooms separated by inner walls extending in a longitudinal direction of the construction profile;
wherein said metallic side profile is provided on a side wall of the polymeric core profile facing the interior, external of said polymeric core profile.

17. The construction profile according to claim 16, wherein the construction profile lacks a metallic side profile structurally attached to the exterior side of the polymeric core profile.

18. The construction profile according to claim 16, wherein said metallic side profile is a hollow profile defining at least one longitudinally extending inner room.

19. The construction profile according to claim 16, wherein said metallic side profile is made of aluminium or steel.

20. The construction profile according to claim 16, comprising inner and outer transversal side edges extending between the room side and the outer side of the construction profile,
wherein the inner transversal side edge defines a pane receiving zone configured to receive a pane when in use and the outer transversal side edge comprises protruding wall parts defining a groove for receiving window or door hardware.

21. The construction profile according to claim 20, wherein at least one of said protruding wall parts defining a groove for receiving window or door hardware is part of the metallic side profile.

22. The construction profile according to claim 20, wherein at least part of the pane receiving zone is defined by the metallic side profile.

23. The construction profile according to claim 20, wherein the metallic side profile defines a fixed rebate of the construction profile.

24. The construction profile according to claim 16, wherein the metallic side profile is attached to the polymeric core profile by one or more of: clips, dovetail connection, adhesives or mechanical fasteners.

25. The construction profile according to claim 16, wherein the attachment of the metallic side profile to the polymeric core profile is at least partially achieved by the intermediate of a glass bridge.

26. A window or door frame comprising construction profiles as identified in claim 16,
wherein the polymeric core profiles of two adjacent construction profiles are welded together at their facing end surfaces.

27. A window or door comprising a window or door frame as identified in claim 26 and comprising a pane installed in the window or door frame,
wherein said pane is positioned off-set the centre of the depth of the window or door frame towards the interior facing side of the window or door frame.

28. A window or door according to claim 26, comprising a glass bridge comprising a first section positioned between a glass pane and the polymeric core profile, said glass bridge comprising a section engaging the metallic side profile and a lever provided between the first and second sections of the glass bridge configured to transfer at least part of the force exerted by the glass pane on the first section of the glass bridge to the metallic side profile.

29. The window or door frame according to claim 26, said frame being a sash frame.

30. The window or door frame according to claim 26, said frame being a fixed frame.
